(19) United States
(12) Patent Application Publication
(10) Pub. No.: US 2020/0130401 A1
(43) Pub. Date: Apr. 30, 2020

(54) STEERING WHEEL MOUNTED CLIPBOARD ASSEMBLY

(71) Applicant: Stanley Rogers, Stanley, NC (US)

(72) Inventor: Stanley Rogers, Stanley, NC (US)

(21) Appl. No.: 16/176,536

(22) Filed: Oct. 31, 2018

(51) Int. Cl. B42F 9/00; B60R 7/04

(52) U.S. Cl. CPC B42F 9/001; B60R 7/04

(57) ABSTRACT

A steering wheel mounted clipboard assembly for mounting a clipboard to a steering wheel includes a vehicle that has a steering wheel. A box is positionable on the steering wheel such that the box is accessible to a driver of the vehicle. A pair of clips is each releasbly attached to the box and each of the clips engages the steering wheel to retain the box on the steering wheel. A clipboard is hingedly coupled to the box and an object can be positioned thereon thereby facilitating the object to be accessible to the driver.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to clipboard devices and more particularly pertains to a new clipboard device for mounting a clipboard to a steering wheel.

### BRIEF SUMMARY OF THE INVENTION

An embodiment of the disclosure meets the needs presented above by generally comprising a vehicle that has a steering wheel. A box is positionable on the steering wheel such that the box is accessible to a driver of the vehicle. A pair of clips is each releasbly attached to the box and each of the clips engages the steering wheel to retain the box on the steering wheel. A clipboard is hingedly coupled to the box and an object can be positioned thereon thereby facilitating the object to be accessible to the driver.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a steering wheel mounted clipboard assembly according to an embodiment of the disclosure.

FIG. 2 is a right side phantom view of an embodiment of the disclosure.

FIG. 3 is a bottom view of an embodiment of the disclosure.

FIG. 4 is a top view of an embodiment of the disclosure.

FIG. 5 is an exploded perspective view of a clip and an aperture of an embodiment of the disclosure.

FIG. 6 is a perspective in-use view of an embodiment of the disclosure.

### DETAILED DESCRIPTION OF THE INVENTION

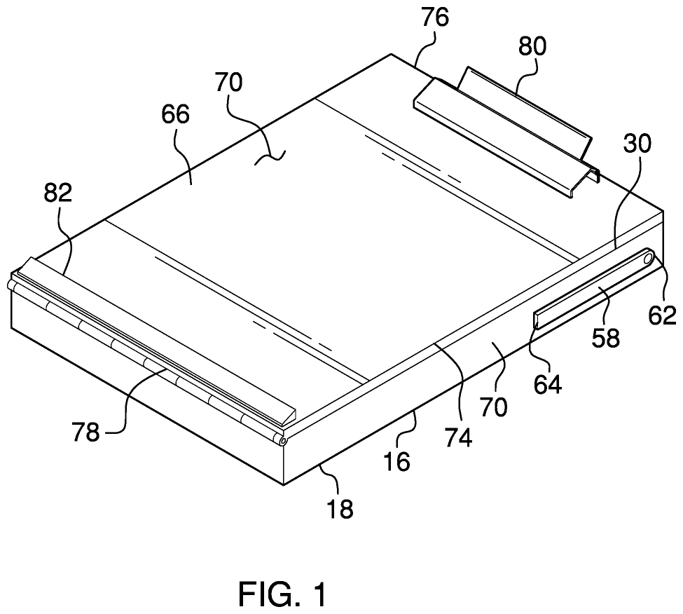

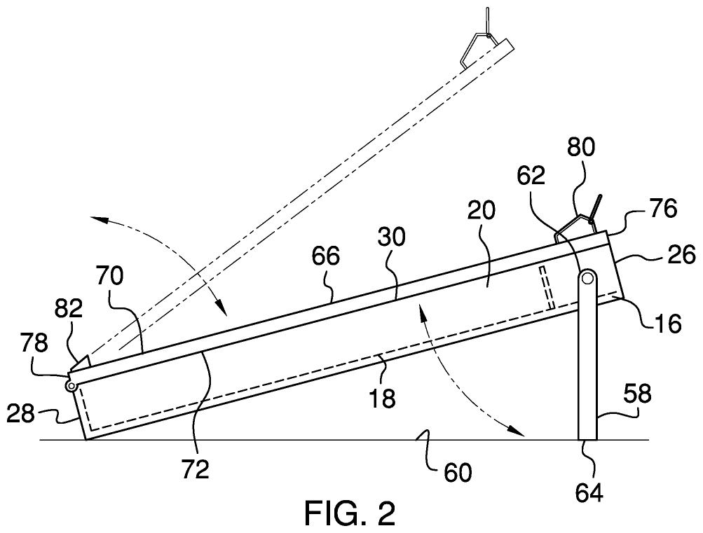

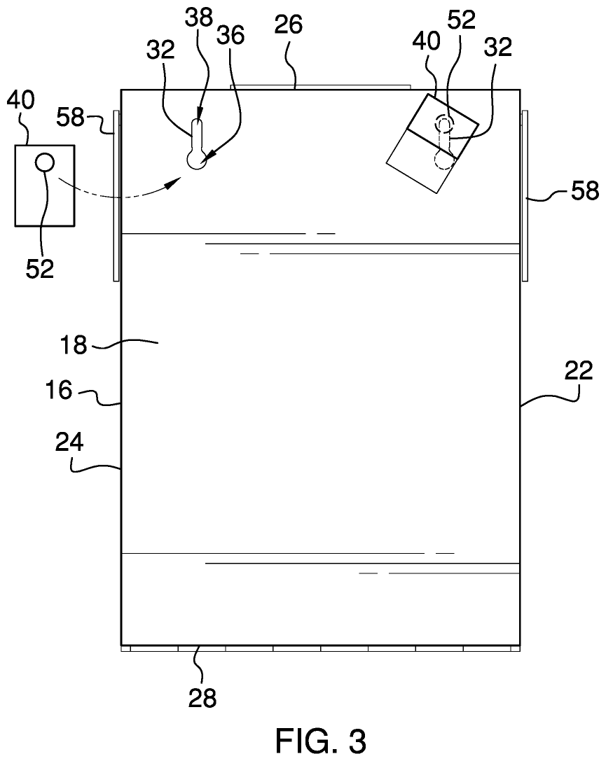

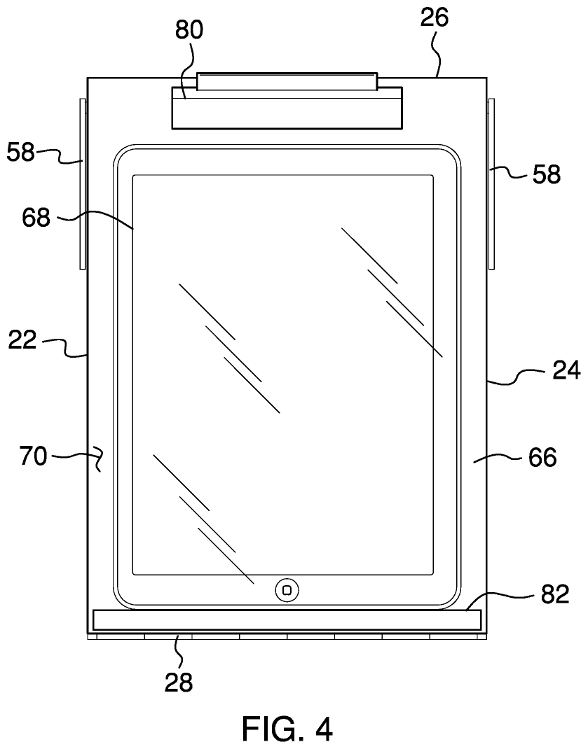

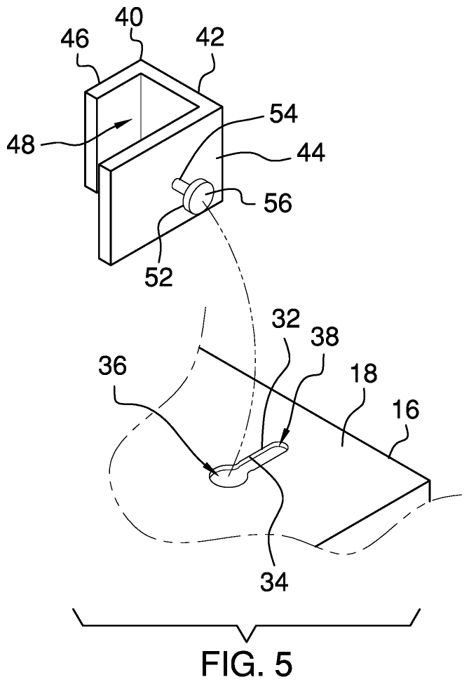

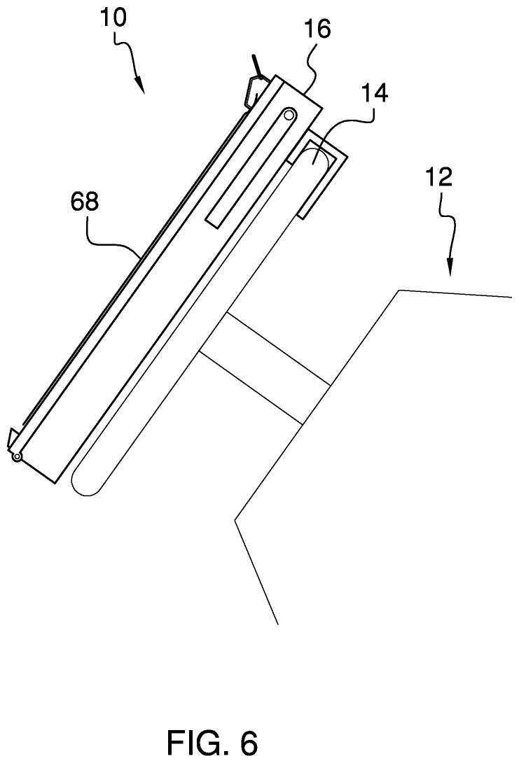

With reference now to the drawings, and in particular to FIGS. 1 through 6 thereof, a new clipboard device embodying the principles and concepts of an embodiment of the disclosure and generally designated by the reference numeral 10 will be described.

As best illustrated in FIGS. 1 through 6, the steering wheel mounted clipboard assembly 10 generally comprises a vehicle 12 that has a steering wheel 14. The vehicle 12 may be an over-the-road semi tractor, a passenger vehicle or any other type of motorized vehicle. A box 16 is positionable on the steering wheel 14 such that the box 16 is accessible to a driver of the vehicle 12. The box 16 has a rear wall 18 and a perimeter wall 20 extending forwardly therefrom; the perimeter wall 20 has a first lateral side 22, a second lateral side 24, a front side 26, a back side 28 and a distal edge 30 with respect to the rear wall 18. The rear wall 18 has a pair of apertures 32 each extending into an interior of the box 16 and each of the apertures 32 has a bounding edge 34. The bounding edge 34 of each of the apertures 32 has a circular portion 36 interesting with a slot portion 38. Moreover, the apertures 32 are spaced apart from each other and are positioned closer to the front side 26 than the back side 28.

A pair of clips 40 is provided and each of the clips 40 is releasbly attached to the box 16, and each of the clips 40 engages the steering wheel 14 to retain the box 16 on the steering wheel 14. Each the clips 40 have a central portion 42 extending between a first lateral portion 44 and a second lateral portion 46. The first lateral portion 44 has a length that is greater than a length of the second lateral portion 46. Moreover, the first 44 and second 46 lateral portions are spaced apart from each other to define a steering wheel space 48 therebetween and the first lateral portion 44 has an outwardly facing surface 50.

A pair of pins 52 is included and each of the pins 52 comprises a stem 54 and a head 56. The stem 54 of each of the pins 52 is coupled to the outwardly facing surface 50 of the first lateral portion 44 of a respective one of the clips 40. The head 56 of each pin is insertable into the circular portion 36 of a respective one of the apertures 32 and the stem 54 is slid into the slot portion 38 of the respective aperture. In this way the pins 52 are retained in the respective aperture.

A pair of legs 58 is provided and each of the legs 58 is pivotally coupled to the box 16. Each of the legs 58 is positionable in a deployed position having each of the legs 58 extending away from the box 16 to abut a support surface 60, such as a table or other horizontal support surface 60. In this way the box 16 can be angled upwardly on the support surface 60. Each of the legs 58 is positionable in a stored position having each of the legs 58 lying against the box 16. Each of the legs 58 has a first end 62 and a second end 64, and the first end 62 of each of the legs 58 is pivotally coupled to a respective one of the first 22 and second 24 lateral sides of the perimeter wall 20 of the box 16.

A clipboard 66 is hingedly coupled to the box 16 and an object 68, such as an I-pad, Smartphone or other object 68 with an electronic display can positioned thereon thereby facilitating the object 68 to be accessible to the driver. The clipboard 66 has a first surface 70, a second surface 72 and a perimeter edge 74 extending therebetween, and the perimeter edge 74 has a forward side 76 and a rear side 78. The clipboard 66 has a spring loaded clip 80 that is hingedly positioned on the first surface 70 for engaging and thereby retaining paperwork on the clipboard 66. The spring loaded clip 80 is positioned adjacent to the forward side 76.

A stop 82 is coupled to and extends away from the first surface 70 of the clipboard 66. The object 68 abuts the stop 82 when the object 68 is positioned on the clipboard 66. In this way the stop 82 inhibits the object 68 from sliding off of the clipboard 66 when the box 16 is positioned on the steering wheel 14. The stop 82 is aligned with and is coextensive with the rear side 78 of the perimeter edge 74 of the clipboard 66.

In use, each of the clips 40 is coupled to the box 16 and the box 16 is positioned on the steering wheel 14 having each of the clips 40 engaging the steering wheel 14. In this way the clipboard 66 is accessible to the driver while the driver is seated behind the steering wheel 14. The object 68 is positioned on the clipboard 66 thereby facilitating the object 68 to be manipulated by the driver. In this way an over-the-road truck driver can perform electronic paperwork or the like when the truck driver is seated in the truck. Additionally, the legs 58 can be deployed for angling the box 16 on the support surface 60.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A steering wheel mounted clipboard assembly being removably positionable on a steering wheel in a vehicle wherein said assembly is configured to be accessible to a driver of the vehicle, said assembly comprising:
a vehicle having a steering wheel;
a box being positionable on said steering wheel wherein said box is configured to be accessible to a driver of said vehicle;
a pair of clips, each of said clips being releasbly attached to said box, each of said clips engaging said steering wheel to retain said box on said steering wheel; and
a clipboard being hingedly coupled to said box wherein said clipboard is configured to have an object positioned thereon thereby facilitating the object to be accessible to the driver.

2. The assembly according to claim 1, wherein:
said box has a rear wall and a perimeter wall extending forwardly therefrom, said perimeter wall having a first lateral side, a second lateral side, a front side, a back side and a distal edge with respect to said rear wall; and
said rear wall has a pair of apertures each extending into an interior of said box, each of said apertures having a bounding edge, said bounding edge of each of said apertures having a circular portion intersecting with a slot portion, said apertures being spaced apart from each other and being positioned closer to said front side than said back side.

3. The assembly according to claim 2, further comprising:
each of said clips having a central portion extending between a first lateral portion and a second lateral portion, said first lateral portion having a length being greater than a length of said second lateral portion, said first and second lateral portions being spaced apart from each other to define a steering wheel space therebetween, said first lateral portion having an outwardly facing surface; and
a pair of pins, each of said pins comprising a stem and a head, said stem of each of said pins being coupled to said outwardly facing surface of said first lateral portion of a respective one of said clips, said head being inserted into said circular portion of a respective one of said apertures having said stem being slid into said slot portion of said respective aperture thereby retaining said pin in said respective aperture.

4. The assembly according to claim 2, further comprising a pair of legs, each of said legs being pivotally coupled to said box, each of said legs being positionable in a deployed position having each of said legs extending away from said box wherein each of said legs is configured to abut a support surface, each of said legs being positionable in a stored position having each of said legs lying against said box, each of said legs having a first end and a second end, said first end of each of said legs being pivotally coupled to a respective one of said first and second lateral sides of said perimeter wall of said box.

5. The assembly according to claim 2, wherein said clipboard has a first surface, a second surface and a perimeter edge extending therebetween, said perimeter edge having a forward side and a rear side, said clipboard having a spring loaded clip being hingedly positioned on said first surface for engaging and thereby retaining paperwork on said clipboard, said spring loaded clip being positioned adjacent to said forward side.

6. The assembly according to claim 5, further comprising a stop being coupled to and extending away from said first surface of said clipboard wherein said stop is configured to inhibit the object from sliding off of said clipboard when said box is positioned on said steering wheel, said stop being aligned with and being coextensive with said rear side of said perimeter edge of said clipboard.

7. A steering wheel mounted clipboard assembly being removably positionable on a steering wheel in a vehicle wherein said assembly is configured to be accessible to a driver of the vehicle, said assembly comprising:
a vehicle having a steering wheel;
a box being positionable on said steering wheel wherein said box is configured to be accessible to a driver of said vehicle, said box having a rear wall and a perimeter wall extending forwardly therefrom, said perimeter wall having a first lateral side, a second lateral side, a front side, a back side and a distal edge with respect to said rear wall, said rear wall having a pair of apertures each extending into an interior of said box, each of said apertures having a bounding edge, said bounding edge of each of said apertures having a circular portion intersecting with a slot portion, said apertures being spaced apart from each other and being positioned closer to said front side than said back side;
a pair of clips, each of said clips being releasbly attached to said box, each of said clips engaging said steering wheel to retain said box on said steering wheel, each said clips having a central portion extending between a first lateral portion and a second lateral portion, said first lateral portion having a length being greater than a length of said second lateral portion, said first and second lateral portions being spaced apart from each other to define a steering wheel space therebetween, said first lateral portion having an outwardly facing surface;
a pair of pins, each of said pins comprising a stem and a head, said stem of each of said pins being coupled to said outwardly facing surface of said first lateral portion of a respective one of said clips, said head being inserted into said circular portion of a respective one of said apertures having said stem being slid into said slot portion of said respective aperture thereby retaining said pin in said respective aperture;
a pair of legs, each of said legs being pivotally coupled to said box, each of said legs being positionable in a deployed position having each of said legs extending away from said box wherein each of said legs is configured to abut a support surface, each of said legs being positionable in a stored position having each of said legs lying against said box, each of said legs having a first end and a second end, said first end of each of said legs being pivotally coupled to a respective one of said first and second lateral sides of said perimeter wall of said box;
a clipboard being hingedly coupled to said box wherein said clipboard is configured to have an object positioned thereon thereby facilitating the object to be accessible to the driver, said clipboard having a first surface, a second surface and a perimeter edge extending therebetween, said perimeter edge having a forward side and a rear side, said clipboard having a spring loaded clip being hingedly positioned on said first surface for engaging and thereby retaining paperwork on said clipboard, said spring loaded clip being positioned adjacent to said forward side; and
a stop being coupled to and extending away from said first surface of said clipboard wherein said stop is configured to inhibit the object from sliding off of said clipboard when said box is positioned on said steering wheel, said stop being aligned with and being coextensive with said rear side of said perimeter edge of said clipboard.
